(19) United States
(12) Patent Application Publication
(10) Pub. No.: US 2013/0175067 A1
(43) Pub. Date: Jul. 11, 2013

(54) GRIP SURFACE FOR A POWER TOOL

(71) Applicant: Thomas Parel, Anderson, SC (US)

(72) Inventor: Thomas Parel, Anderson, SC (US)

(21) Appl. No.: 13/345,060

(22) Filed: Jan. 6, 2012

(51) Int. Cl. B25F 5/02; B25G 1/10; B32B 3/00

(52) U.S. Cl. 173/170; 428/141

(57) ABSTRACT

An overmolded grip for a power tool having a size, a 3-dimensional shape, and certain material properties to aid the user in gripping a power tool or the like.

### FIELD OF THE INVENTION

The present invention relates generally to power tools, such as power drills, power saws, and power sanders, and more specifically, to gripping surfaces used on such power tools.

### BACKGROUND

Power tools are used in various applications to allow a user to quickly accomplish a task such drilling a hole, cutting a board, or sanding a surface.

### SUMMARY

In one embodiment, the invention provides a handheld power tool having a case having an interior portion, an electric motor disposed in the interior portion of the case, and a base having a surface area, said base coupled to the case. The invention also includes a plurality of protuberances coupled to the base, at least one protuberance having at least one side surface and a top surface, the at least one side surface forming a first angle of between 85 and 95 degrees with the base, and forming a second angle of between 85 and 95 degrees with the top.

In another embodiment the invention provides an overmolded grip for a tool which includes a base having a surface area. The invention further includes a plurality of protuberances coupled to the base, at least one protuberance having at least one side surface and a top surface, the at least one side surface forming a first angle of between 85 and 95 degrees with the base, and forming a second angle of between 85 and 95 degrees with the top.

Yet another embodiment of the invention a grip for defining a gripping surface for a tool having a polymer base layer, and a microtexture coupled to the base layer, said microtexture comprising a plurality of protuberances wherein a side surface of at least one protuberance of said plurality of protuberances forms an angle of between 85 and 95 degrees with said base layer. The invention further includes a second protuberance disposed proximate to an overmold border wherein the second protuberance has a height that is less than the height of the at least one protuberance.

Other aspects of the invention will become apparent by consideration of the detailed description and accompanying drawings.

### BRIEF DESCRIPTION OF THE DRAWINGS

FIG. 1 is a perspective view of a power tool.

FIG. 2 is a perspective view of a first portion of a gripping surface of the power tool of FIG. 1.

FIG. 3 is a perspective view of a second portion of the gripping surface of the power tool of FIG. 1.

FIG. 4 is a partial section view taken along line 4-4 in FIG. 1.

FIG. 5 is a perspective view of an alternative embodiment of a gripping surface.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

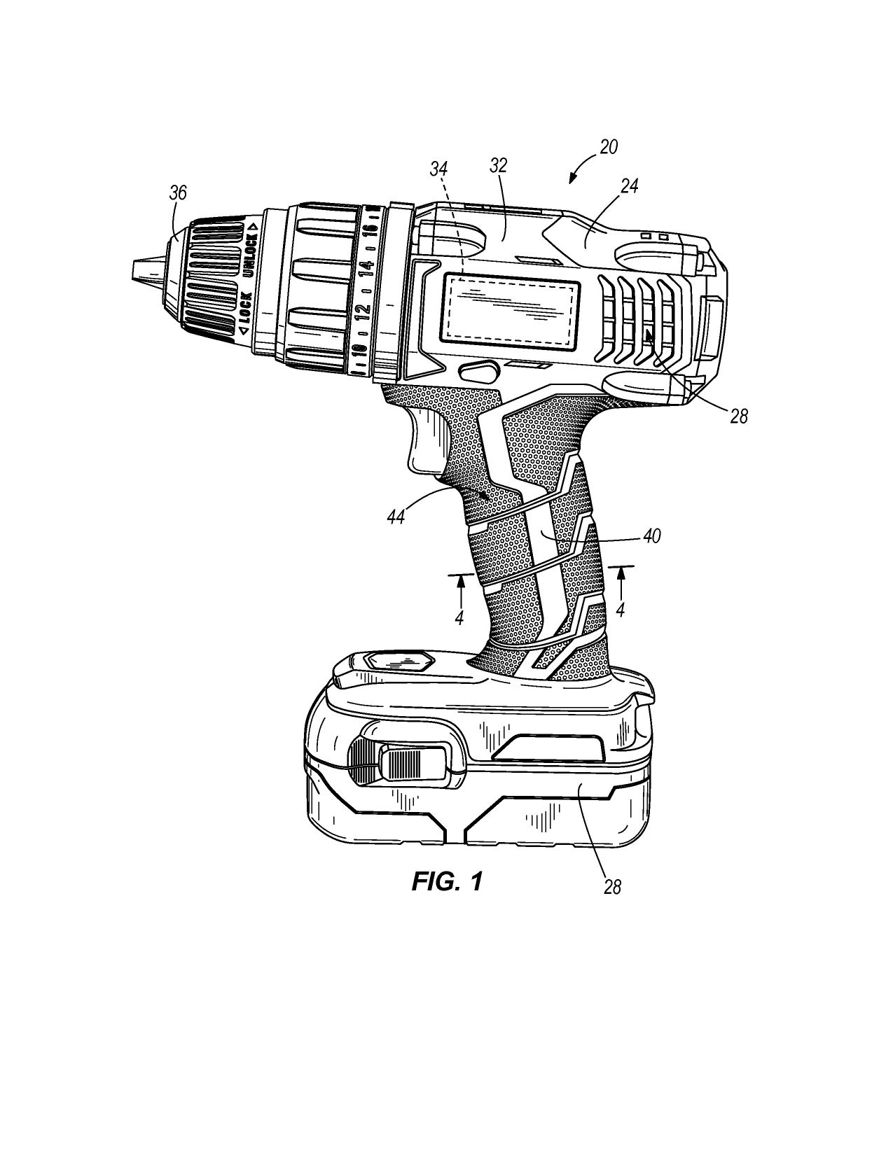

A power tool 20 is illustrated in FIG. 1. Although FIG. 1 illustrates a power drill, it is to be understood that the invention described herein equally applies to a power saw, a power sander, a power hammer-drill and many other power tools. The power tool 20 has a case 24 having an interior portion 28 and an exterior portion 32. An electric motor 34, indicated in ghost lines in FIG. 1, is disposed in the interior portion 28 of the case and serves to power a working component 36 of the power tool 20. The electric motor 34 is powered by a battery 38. An overmolded grip 40 is coupled to the exterior portion 32. In the illustrated embodiment the overmolded grip 40 covers a gripping surface 44 of the power tool 20, the gripping surface 44 being the area of the power tool 20 that is usually contacted by one or more of an operator's hands. In an alternative embodiment the overmolded grip 40 covers the gripping surface 44 and an additional part of the exterior portion 32. In another alternative embodiment, the overmolded grip 40 covers only a part of the gripping surface 44.

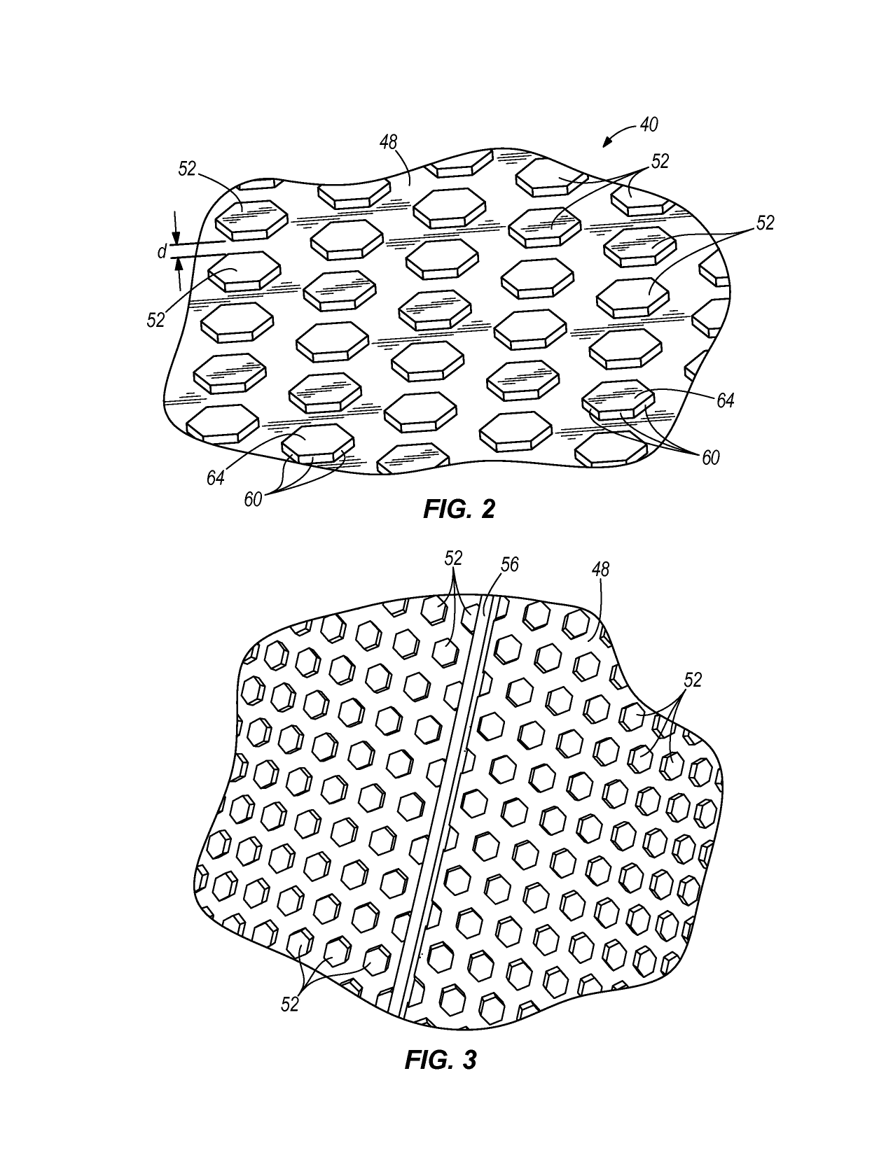

The overmolded grip 40 includes a base 48, as seen in FIG. 2, composed of a polymer. In one embodiment the polymer used is GALLONPRENE, although other polymers such as polypropylene are contemplated. The base 48 may be coupled to the exterior portion 32 using an adhesive. Other embodiments of the power tool 20 may have the base 48 coupled to the exterior portion 32 using one or more fasteners such as, by way of example only, a screw or staple.

The overmolded grip 40 also includes a plurality of protuberances 52 coupled to the base 48. The plurality of protuberances 52 cover a portion of the base 48. In an alternative embodiment, the plurality of protuberances 52 cover the entire base 48. In the illustrated embodiment the plurality of protuberances 52 are composed of GALLONPRENE; other embodiments contemplate using other polymers such as polypropylene. In some embodiments the plurality of protuberances 52 coupled to the base 48 are known as a microtexture.

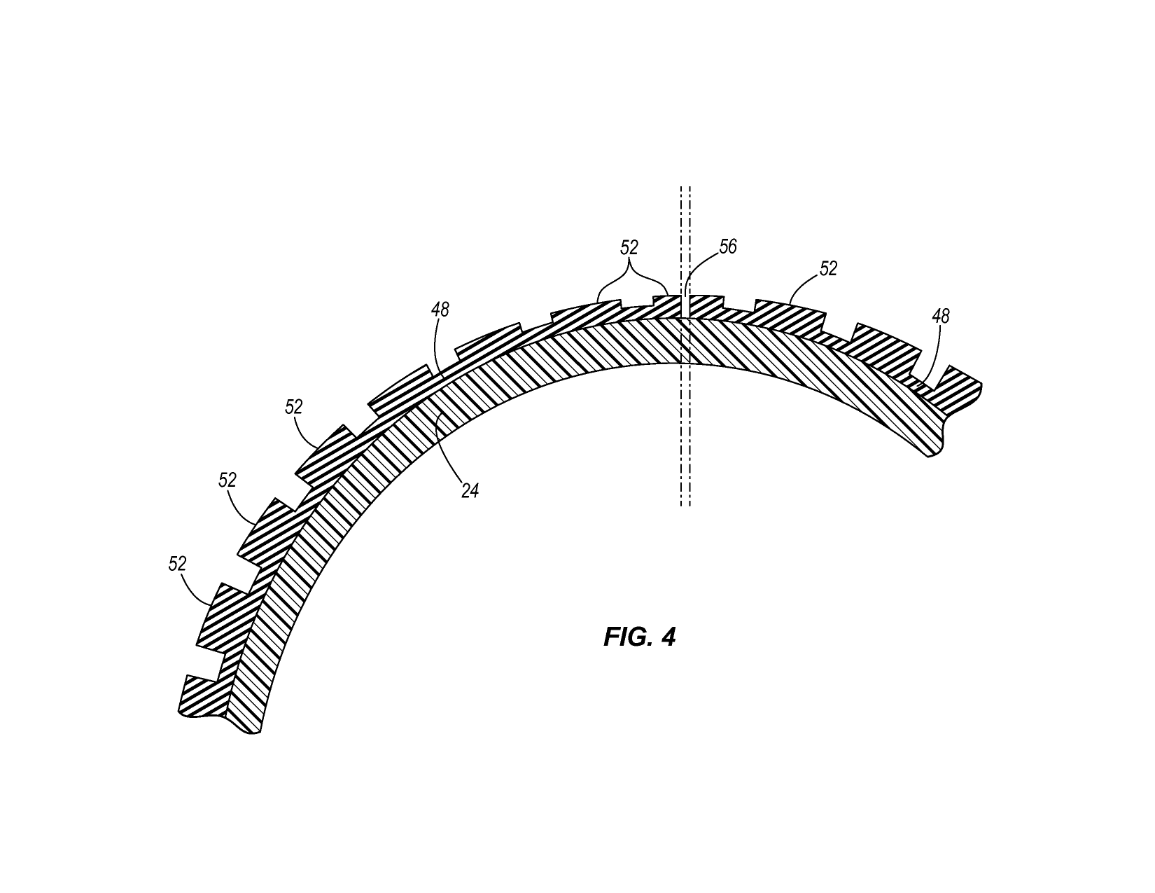

As can be seen in FIGS. 3 and 4, the protuberances 52 disposed near an overmold border 56 are slightly different from other protuberances 52. The protuberances 52 which directly touch the overmold border, as seen in FIG. 3, may have a different shape than the other protuberances 52, as the overmold border 56 cuts off a portion of a protuberance 52.

FIG. 4 illustrates the height difference of protuberances 52 that are disposed proximate to the overmold border 56. The protuberances 52 that are disposed closer to the overmold border 56 are shorter, relative to the base 48, than the protuberances 52 which are disposed further away from the overmold border 56. The protuberances 52 that are a set distance away from the overmold border 56 have substantially the same height relative to the base 48. It has been found that a gradual change in height of the protuberances 52 near the overmold border 56 allows the user to have a firmer and more comfortable grip on the power tool 20. In addition, it has been found that the gradual change in height of the protuberances 52 near the overmold border 56 means that the overmold border 56 is less likely to irritate the user.

The protuberances 52 that are set closer to the overmold border 56 have a height, relative to the base 48, of approximately 0.0079 inches. In an alternative embodiment the height of the protuberances 52 that are set a distance away from the overmold border 56 have a height, relative to the base 48, of between 0.006 and 0.01 inches.

Each protuberance 52 has certain qualities that allow the user to comfortably and firmly grasp the power tool 20. As seen in FIG. 2, each protuberance 52 has multiple side surfaces 60 and a top surface 64. Each side surface 60 forms an angle of between 85 and 95 degrees with the base 48. An alternative embodiment of the invention has each side surface 60 forming an angle of between 88 and 92 degrees with the base 48. Each side surface 60 forms an angle of between 85 and 95 degrees with the top surface 64. An alternative embodiment of the invention has each side surface 60 forming an angle of between 88 and 92 degrees with the top surface 64. It has been found that the angle formed by the intersection of the side surface 60 and the top surface 64, and the angle formed by the side surface 60 and the base 48, greatly aids the user's grip of the power tool 20.

In the illustrated embodiment each protuberance 52 has a melt flow index of approximately 50 grams/10 minutes, a specific gravity of approximately 1.05 grams/cubic centimeter, a tensile strength of approximately 30 kilograms-f/square centimeter, a break elongation of approximately 400% and a hardness of approximately 55 shore A. In an alternative embodiment of the invention each protuberance 52 has a melt flow index between 45 and 55 grams/10 minutes, a specific gravity between 1.00 and 1.10 grams/cubic centimeter, a tensile strength between 27 and 33 kilograms-f/square centimeter, a break elongation between 375% and 425% and a hardness between 53 and 57 shore A. In the illustrated embodiment the base 48 has the same qualities as each protuberance 52. In an alternative embodiment the base 48 has different qualities than each protuberance 52. It has been found that using protuberances 52 with the aforementioned properties aids the user in establishing a firm grip of the power tool 20.

In the illustrated embodiment each protuberance 52 has the shape of a hexagonal prism, as seen in FIG. 2. Each side surface 60 of each protuberance 52 is approximately equal in size. The top surface 64 of each protuberance 52 has an area of approximately 0.0019 square inches. In an alternative embodiment, the top surface 64 of each protuberance 52 has an area between 0.0015 and 0.0023 square inches. The distance d, as seen in FIG. 2, between two protuberances 52 is approximately 0.04 inches. In an alternative embodiment, the distance d between two protuberances 52 is between 0.03 and 0.05 inches.

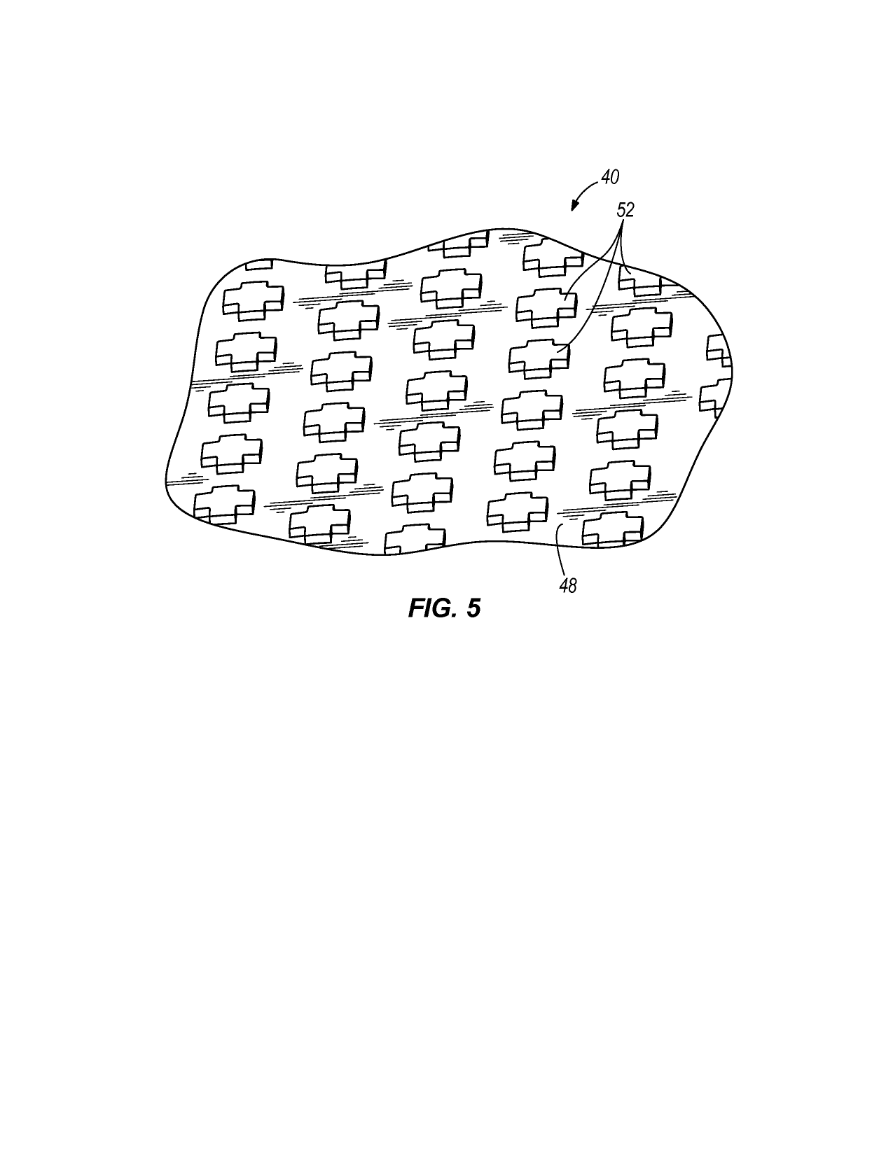

An alternative embodiment of the invention is illustrated in FIG. 5. Each protuberance 52 in the alternative embodiment is in the shape of a 3-dimensional (extruded) “plus” sign, instead of a hexagonal prism. Other alternative embodiments contemplate using different shapes. In these alternative embodiments the protuberances 52 share the same qualities, with the exception of shape, with the protuberances 52 described earlier.

Testing has shown that the combination of protuberance size, protuberance height relative to the base 48, and the angle of the top surface 64 with respect to the side surface 60, in combination with the material properties of each protuberance 52, results in a gripping surface that is superior to other grips currently on the market. The overmolded grip 40 described herein is much easier to use and hold than grips currently on the market, especially in dusty, dirty and/or wet conditions.

Thus, the invention provides, among other things, a power tool with an overmolded grip. Various features and advantages of the invention are set forth in the following claims.

What is claimed is:

1. A handheld power tool comprising:
a case having an interior portion;
an electric motor disposed in the interior portion;
a base having a surface area, said base coupled to the case; and
a plurality of protuberances coupled to the base, at least one protuberance having at least one side surface and a top surface, the at least one side surface forming a first angle of between 85 and 95 degrees with the base, and forming a second angle of between 85 and 95 degrees with the top.

2. The handheld power tool of claim 1 wherein the at least one protuberance has a hardness of between 53 and 57 shore A.

3. The handheld power tool of claim 2 wherein the top surface of the at least one protuberance has a surface area of between 0.0015 square inches and 0.0023 square inches.

4. The handheld power tool of claim 3 wherein the at least one protuberance extends a distance of between 0.006 inches and 0.010 inches from the base.

5. The handheld power tool of claim 4 wherein the at least one protuberance is in the shape of a hexagon.

6. The handheld power tool of claim 4 wherein the at least one protuberance is in the shape of a plus sign.

7. The handheld power tool of claim 1 wherein the base is disposed on a gripping area of the handheld power tool.

8. The handheld power tool of claim 1 wherein a second protuberance of the plurality of protuberances extends a distance from the base that is less than the distance that the at least one protuberance extends from the base, the second protuberance being disposed so that a portion of the second protuberance touches an overmold border.

9. An overmolded grip for a tool comprising:
a base having a surface area; and
a plurality of protuberances coupled to the base, at least one protuberance having at least one side surface and a top surface, the at least one side surface forming a first angle of between 85 and 95 degrees with the base, and forming a second angle of between 85 and 95 degrees with the top.

10. The surface for gripping of claim 9 wherein the at least one protuberance has a hardness of between 53 and 57 shore A.

11. The surface for gripping of claim 10 wherein the top surface of the at least one protuberance has a surface area of between 0.0015 square inches and 0.0023 square inches.

12. The surface for gripping of claim 11 wherein the at least one protuberance extends a distance of between 0.006 inches and 0.010 inches from the base.

13. The surface for gripping of claim 12 wherein the at least one protuberance is in the shape of a hexagon.

14. The surface for gripping of claim 12 wherein the at least one protuberance is in the shape of a plus sign.

15. The surface for gripping of claim 9 wherein a second protuberance of the plurality of protuberances extends a distance from the base that is less than the distance that the at least one protuberance extends from the base, the second protuberance being disposed so that a portion of the second protuberance touches an overmold border.

16. A grip for defining a gripping surface for a tool comprising:
a polymer base layer;
a microtexture coupled to the base layer and defining an overmolded border therebetween, said microtexture comprising a first protuberance having a side surface that forms an angle of between 85 and 95 degrees with said base layer; and
a second protuberance disposed proximate to the overmold border wherein the second protuberance has a height that is less than the height of the first protuberance.

17. The grip for defining a gripping surface for a tool of claim 16 wherein the side surface of the first protuberance forms an angle of between 85 and 95 degrees with a top surface of the first protuberance.

18. The grip for defining a gripping surface for a tool of claim 16 wherein the top surface of the first protuberance has a surface area of between 0.0015 square inches and 0.0023 square inches.

19. The grip for defining a gripping surface for a tool of claim 18 wherein the first protuberance extends a distance of between 0.006 inches and 0.010 inches from the base.

20. The grip for defining a gripping surface for a tool of claim 19 wherein the first protuberance has a hardness of between 53 and 57 shore A.
